(19) United States
(12) Patent Application Publication
(10) Pub. No.: US 2011/0041655 A1
(43) Pub. Date: Feb. 24, 2011

(54) Bottle cap opener

(76) Inventor: Rodrigo Muniz, Midland, TX (US)

Correspondence Address: Gordon W. Dyer, Esq., 1300 N. Dal Paso St., Hobbs, NM, 88240, US

(21) Appl. No.: 12/583,735

(22) Filed: Aug. 24, 2009

(51) Int. Cl. B67B 7/00; B67B 7/16

(52) U.S. Cl. 81/3.08; 81/3.55

(57) ABSTRACT

The invention is a bottle cap opener with an attached storage compartment in its handle to temporarily store, for later disposal, the bottle caps that it removes from a bottle in order to prevent bottle cap floor litter. The handle may be transparent in order to aid the user in determining when the storage compartment is full enough to warrant disposing of the stored, removed bottle caps.

### BACKGROUND OF THE INVENTION

1. Field of the Invention

This invention deals with bottle openers of the type used to remove standard bottle caps. More specifically, the present invention deals with how to remove standard bottle caps in such a manner that the caps end up in a container rather than randomly falling away from the bottle after being removed.

Standard bottle cap means a bottle cap that seals the opening to the bottle by being crimped or screwed onto the bottle cap and that may be removed from the bottle by prying or unscrewing force, respectively. However, the present invention encompasses the removal and storage of all types of caps known in the art from any container, not just bottles.

2. Description of Related Art

Prior bottle cap openers have tended to deal only with how to remove caps from a bottle but do not teach how to facilitate the disposition of the caps into a container after their removal.

Rowland, U.S. Pat. No. 4,433,597, teaches a bottle cap opener which can be used to remove the caps from either screw-type or pry-off bottles but does not teach how to prevent these caps from littering the working area of a busy bartender. Rowland therefore has no provision for preventing work-related injuries stemming from slips and falls caused by the bartender accidentally stepping on the slippery bottle caps that end up strewn on the floor of his or her working area. Further, Rowland does not teach how to prevent the bartender from having to perform the additional work of picking up these bottle caps when he cleans up his work area at the end of his shift.

U.S. Pat. No. 3,038,178 (Schumacher) discloses a bottle cap removing device that incorporates a temporary storage compartment adapted to receive the bottle cap for the sole purpose of recapping the bottle. No long term storage of the caps is envisioned, nor does its storage compartment allow for the storage of more than one bottle cap at a time. Further, Schumacher discloses only how to remove crimped-type bottle caps and thus has no provision for how to remove screw-type bottle caps.

U.S. Pat. App. No. 2003/0164070 A1 (Marxrieser), like Schumacher, discloses a bottle cap removing device that incorporates a temporary storage compartment adapted to receive the bottle cap for the sole purpose of recapping the bottle. No long term storage of the caps is envisioned, nor does its storage compartment allow for the storage of more than one bottle cap at a time. Marxrieser further discloses a more ergonomic design than does Schumacher and, unlike Schumacher, can be used to remove both either screw or crimp-type bottle caps.

Because all of the above references either have no provision for storage of bottle caps or storage of a bottle cap only for the purpose of recapping the bottle, it would be desirable to provide a bottle cap opener with a storage container to store bottle caps for later disposal in order to help prevent bottle cap litter.

### SUMMARY OF THE INVENTION

It is an object of the present invention to provide a bottle/container opener, capable of being used by an operator to exert force and insert capped bottles, having a bottle cap storage compartment within its handle, for removing caps from bottles/containers and temporarily storing the removed bottle/container caps in the compartment, comprising an inverted hand shovel shape having a tunnel with a slot-shaped front aperture and a back aperture which leads to a hollow handle, which may partially or completely transparent, a top having a front and a back which is substantially flat and adapted to receive the top of a bottle cap, sides which, after a length from the front of the top sufficient to receive the diameter of a bottle cap edgewise descend substantially perpendicular from the top and lip over towards one another in a horse shoe-shape fashion to form flanges having a prying surface and which, together with the top and sides, comprise the slot-shaped front aperture which is adapted to receive the bottom and sides of a bottle cap, a holder having holding ability located within the top slightly less than the radius of a bottle cap in front of the front aperture which is a adapted to receive and temporarily hold the top of a bottle cap, whereby, when the operator inserts a capped bottle/container into the slot-shaped front aperture until the side of the cap and bottle/container rest against the horse shoe-shaped prying surface and pulls up on the handle, the upward force pries the cap off the bottle/container, the force of the insertion displaces a previous bottle cap, if any, from the holder down the tunnel and into the storage compartment of the handle and, by the holding force of the holder, the new bottle cap is retained by the holder.

It is a further object of the present invention to provide a bottle opener that has a holder for holding and temporarily retaining the bottle cap of an opened bottle wherein the holding ability of the holder is magnetic.

It is a further object of the present invention to provide a bottle opener with a magnetic holder for holding and temporarily retaining the bottle cap of an opened bottle that, when used by an operator, electrical force and the force of the operator's insertion are used to displace the bottle cap from the holder and into the bottle opener's storage compartment.

It is a further object of the present invention to provide a bottle opener with a magnetic holder for holding and temporarily retaining the bottle cap of an opened bottle that, when used by an operator, electromagnetic force and the force of the operator's insertion are used to displace the bottle cap from the holder and into the bottle opener's storage compartment.

It is a further object of the present invention to provide a bottle opener with a magnetic holder for holding and temporarily retaining the bottle cap of an opened bottle that, when used by an operator, vacuum force and the force of the operator's insertion are used to displace the bottle cap from the holder and into the bottle opener's storage compartment.

It is a further object of the present invention to provide a bottle opener with a magnetic holder for holding and temporarily retaining the bottle cap of an opened bottle that, when used by an operator, pneumatic force and the force of the operator's insertion are used to displace the bottle cap from the holder and into the bottle opener's storage compartment.

It is a further object of the present invention to provide a bottle opener that has a holder for holding and temporarily retaining the bottle cap of an opened bottle wherein the holding ability of the holder is mechanical.

It is a further object of the present invention to provide a bottle opener with a mechanical holder for holding and temporarily retaining the bottle cap of an opened bottle that, when used by an operator, electrical force and the force of the operator's insertion are used to displace the bottle cap from the holder and into the bottle opener's storage compartment.

It is a further object of the present invention to provide a bottle opener with a mechanical holder for holding and temporarily retaining the bottle cap of an opened bottle that, when used by an operator, electromagnetic force and the force of the operator's insertion are used to displace the bottle cap from the holder and into the bottle opener's storage compartment.

It is a further object of the present invention to provide a bottle opener with a mechanical holder for holding and temporarily retaining the bottle cap of an opened bottle that, when used by an operator, vacuum force and the force of the operator's insertion are used to displace the bottle cap from the holder and into the bottle opener's storage compartment.

It is a further object of the present invention to provide a bottle opener with a mechanical holder for holding and temporarily retaining the bottle cap of an opened bottle that, when used by an operator, pneumatic force and the force of the operator's insertion are used to displace the bottle cap from the holder and into the bottle opener's storage compartment.

Finally, it is an object of the present invention to provide an improved bottle/container opener for opening capped bottles and containers, the improvement comprising having a holder to temporarily retain the removed cap and having a bottle cap storage compartment within its handle, which may be partially or completely transparent, to store the removed bottle/container caps in the compartment until the transparent view indicates when the operator should dispose of the bottle caps stored in the now full handle.

### BRIEF DESCRIPTION OF THE DRAWINGS

FIG. 1 is an exploded plan view of a bottle opener constructed in accordance with a preferred embodiment of the invention.

FIG. 2 is an upside-down exploded plan view of the bottle opener of FIG. 1.

FIG. 3 shows a version of the bottle opener of FIGS. 1-2 illustrating how the bottle opener interacts with a bottle and a bottle cap.

FIG. 4 shows a flange-front version of the bottle opener and how it interacts with a bottle cap.

### DETAILED DESCRIPTION OF THE INVENTION

In the first version of the present invention the bottle cap opener is shaped like an inverted hand shovel having a front aperture and a back aperture. The top of the bottle opener is substantially flat and is designed to engage the top of a bottle cap. The sides of the bottle opener descend substantially perpendicular to the top and lip over to form flanges designed to engage the bottom and sides of a bottle cap. After a length from the front sufficient to receive the diameter of a bottle cap edgewise the bottom edges of the two flanges merge toward each other to form, together with the top, the slot-shaped front aperture of the bottle cap. The front aperture is sized and shaped to receive a bottle cap edgewise. Located within the top of the bottle opener, slightly less than the radius of a bottle cap in front of the front aperture is a holder designed to temporarily receive and hold magnetically or, by all that is already known to the art, mechanically a bottle cap.

Extending back from the front aperture is a tunnel which ends at the back aperture of the bottle cap opener. The tunnel is adapted to receive and transmit bottle caps edgewise towards the back of the bottle cap opener, through the back aperture and into a hollow handle. The lower portion of the front aperture is semi-circular in shape and is adapted to receive the semi-circular shape of the side of the bottle and the bottom edge of a bottle cap. The semi-circular shape of the lower portion of the front aperture arches forwards towards the flanges to form a horse shoe-shaped prying surface that may be either contiguous or noncontiguous.

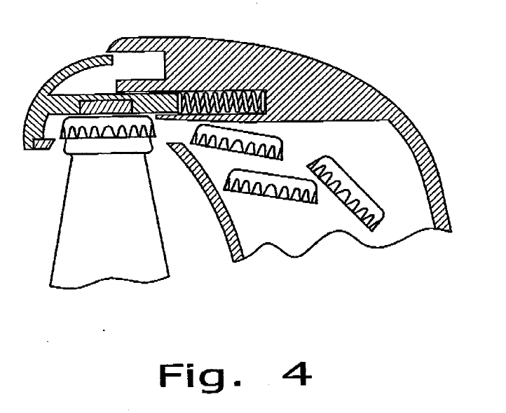

In the second version of the present invention the bottle cap opener is shaped like an ice cream scooper having a front semicircular spring-loaded horizontally moving flange, with mechanical stops limiting the flange's back and forth motion, which is adapted to receive the bottom and side edges of a bottle cap and a back aperture leading to a tunnel having a shim which in turn leads to a hollow handle that may be partially or completely transparent. The top of the flange is substantially flat and has a holder adapted to temporarily receive and magnetically hold or, by all that is already known to the art, mechanically hold a bottle cap. In normal operation, see FIG. 4, the operator descends the scoop-shaped bottle cap opener on to a bottle cap until the flange engages the bottom and side edges of the bottle cap and flange' holder either magnetically or mechanically engages the top of the bottle cap. The operator then pries the bottle cap off the bottle by depressing the handle which in turn causes the front of the flange to exert upward force on the engaged bottle cap, removing it from the bottle. The now removed bottle cap is retained magnetically or mechanically by the holder located in the top of the flange until the operator pulls back the spring-loaded flange which moves the bottle cap through the back aperture and into the tunnel until the bottle cap is displaced from the flange's holder by the tunnel's shim and the bottle cap falls into the storage compartment of the partially or completely transparent hollow handle.

It is a characteristic of the present invention to have a hollow handle designed to receive and store multiple previously removed bottle caps. It is also a characteristic of the present invention that the removed bottle caps be minimally crimped during their removal process in order to maximize the number of bottle caps that may be temporarily stored in a storage compartment located in the opener's hollow handle.

It is a further characteristic of the present invention that its exterior may display logos and/or fashionable designs and colors. Further, it is a characteristic of the invention's handle that it has two apertures. The first aperture is contiguous with the back end of the tunnel and is adapted to receive the removed bottle caps. The second aperture is capable of being opened and closed by the operator and is designed for easy periodic disposal of the bottle caps temporarily stored in the handle.

In normal operation, utilizing the first version of the present invention, the operator inserts the cap of a capped bottle or container through the slot formed between the two flanges until the side of the bottle rests against the prying surface and in the process displaces the cap of any previously removed bottle cap from the holder and simultaneously pushes the displaced bottle cap down the tunnel and into the hollow handle. The operator then lifts up on the handle removing the cap from the bottle. The bottle cap is retained by the holder until it in turn is pushed down the tunnel and into the hollow handle by the operator inserting another capped bottle into the opener in order to remove another bottle cap.

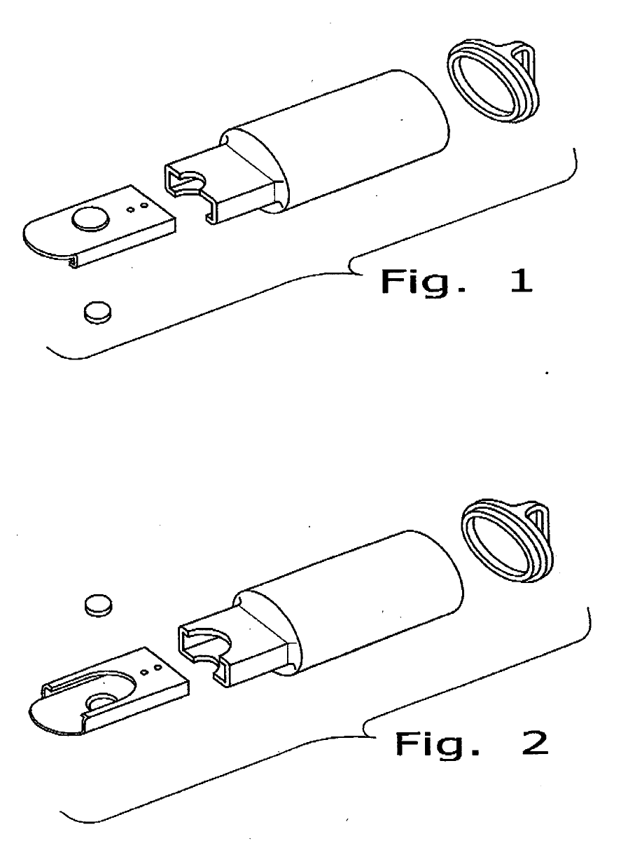

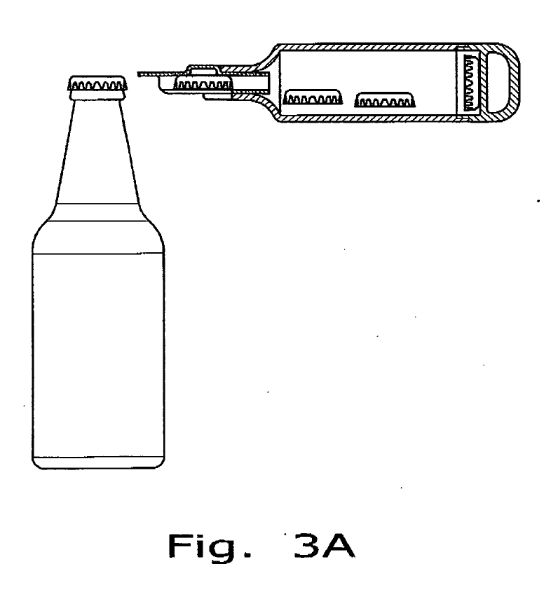

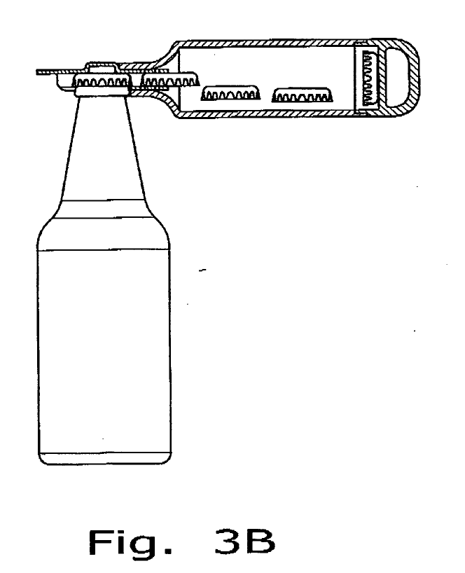

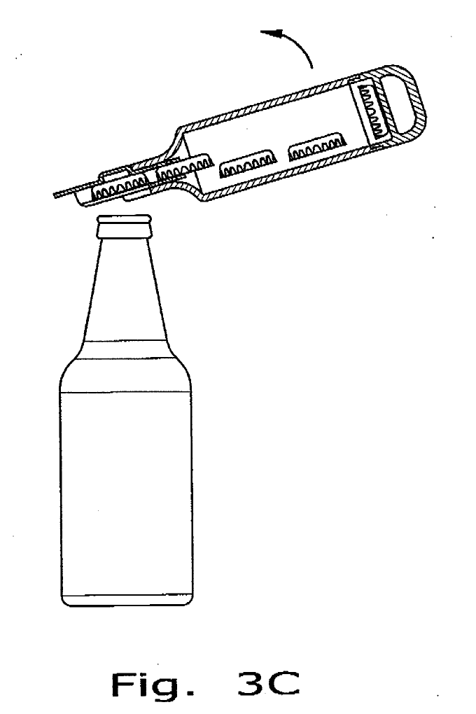

In one variation of the opener of FIGS. 1-3, the motive force propelling the bottle cap through the tunnel and into the hollow handle is the force of the user positioning the cap of a new bottle into the slot between the two flanges to pry off a new cap.

In another variation of the opener of FIGS. 1-3, the motive force propelling the bottle cap through the tunnel and into the hollow handle is electrical.

In another variation of the opener of FIGS. 1-3, the motive force propelling the bottle cap through the tunnel and into the hollow handle is electromagnetic.

In another variation of the opener of FIGS. 1-3, the motive force propelling the bottle cap through the tunnel and into the hollow handle is pneumatic.

In another variation of the opener of FIGS. 1-3, the motive force impelling the bottle cap through the tunnel and into the hollow handle is vacuum.

The bottle opener may be made of metal, plastic, ceramic, or any other material having sufficient durability needed for repeated bottle cap removal. The material may be further coated, embossed of engrained to enhance the bottle opener's texture, feel or appearance.

In a preferred embodiment, the motive force propelling the bottle cap down the tunnel and into the hollow handle is the force of the user positioning the cap of a new bottle into the slot between the two flanges to pry off a new cap and, further, the handle is partially transparent and is made of ABS/PC and the body of the bottle opener is made of progressive die sheet metal.

In another preferred embodiment, the motive force propelling the bottle cap down the tunnel and into the hollow handle is electromagnetic, the handle is made of ABS/PC and the body of the bottle opener is made of progressive die sheet metal.

Although the preferred embodiments of the invention have been described in the forgoing Detailed Description of the Invention, it will be appreciated by those skilled in the art that the invention is not limited to the embodiments disclosed but is capable of modifications without departing from the spirit and scope of the present invention.

What is claimed is:

1. A bottle/container opener, capable of being used by an operator to exert force and insert capped bottles, which has a handle that may be partially or completely transparent and has a bottle cap storage compartment within its handle, for removing caps from bottles/containers and temporarily storing the removed bottle/container caps in the compartment, comprising:
an inverted hand shovel shape having a tunnel with a slot-shaped front aperture and a back aperture which leads to a hollow handle, a top having a front and a back which is substantially flat and adapted to receive the top of a bottle cap, sides which, after a length from the front of the top sufficient to receive the diameter of a bottle cap edgewise descend substantially perpendicular from the top and lip over towards one another in a horse shoe-shape fashion to form flanges having a prying surface and which, together with the top and sides, comprise the slot-shaped front aperture which is adapted to receive the bottom and sides of a bottle cap, a holder having holding ability located within the top slightly less than the radius of a bottle cap in front of the front aperture which is a adapted to receive and temporarily hold the top of a bottle cap, whereby, when the operator inserts a capped bottle/container into the slot-shaped front aperture until the side of the cap and bottle/container rest against the horse shoe-shaped prying surface and pulls up on the handle, the upward force pries the cap off the bottle/container, the force of the insertion displaces a previous bottle cap, if any, from the holder down the tunnel and into the storage compartment of the handle and, by the holding force of the holder, the new bottle cap is retained by the holder.

2. The bottle opener of claim 1 wherein the holding ability of the holder is magnetism.

3. The bottle opener of claim 2 wherein the force of insertion used to displace the bottle cap from the holder into the storage compartment is augmented by electrical force.

4. The bottle opener of claim 2 wherein the force of insertion used to displace the bottle cap from the holder into the storage compartment is augmented by electromagnetic force.

5. The bottle opener of claim 2 wherein the force of insertion used to displace the bottle cap from the holder into the storage compartment is augmented by vacuum force.

6. The bottle opener of claim 2 wherein the force of insertion used to displace the bottle cap from the holder into the storage compartment is augmented by pneumatic force.

7. The bottle opener of claim 1 wherein the holding ability of the holder is mechanical.

8. The bottle opener of claim 7 wherein the force of insertion used to displace the bottle cap from the holder into the storage compartment is augmented by electrical force.

9. The bottle opener of claim 7 wherein the force of insertion used to displace the bottle cap from the holder into the storage compartment is augmented by electromagnetic force.

10. The bottle opener of claim 7 wherein the force of insertion used to displace the bottle cap from the holder into the storage compartment is augmented by vacuum force.

11. The bottle opener of claim 7 wherein the force of insertion used to displace the bottle cap from the holder into the storage compartment is augmented by pneumatic force.

12. A bottle/container opener for opening capped bottles and containers, the improvement comprising:
having a holder to temporarily retain the removed cap and having a bottle cap storage compartment within its handle, which may be partially or completely transparent, to store the removed bottle/container caps in the compartment for later disposal.
